(19) United States
(12) Patent Application Publication
(10) Pub. No.: US 2019/0250481 A1
(43) Pub. Date: Aug. 15, 2019

(54) ELECTRONIC PAPER DISPLAY SCREEN, METHOD FOR DRIVING THE SAME, AND ELECTRONIC PAPER DISPLAY DEVICE

(71) Applicants: BOE Technology Group Co., Ltd., Beijing (CN); Chengdu BOE Optoelectronics Technology Co., Ltd., Chengdu (CN)

(72) Inventors: Bing Xu, Beijing (CN); Dongwang Jia, Beijing (CN); Junping Bao, Beijing (CN); Xinghua Li, Beijing (CN)

(21) Appl. No.: 16/110,467

(22) Filed: Aug. 23, 2018

(30) Foreign Application Priority Data
Feb. 13, 2018 (CN) 201810150681.8

(51) Int. Cl. G02F 1/167; G02F 1/1339; F21V 8/00; G02F 1/1335; G02F 1/1343; H05B 37/02

(52) U.S. Cl. CPC G02F 1/167; G02F 1/13394; G02B 6/0068; G02F 1/133606; H02S 99/00; H05B 37/0218; G02F 1/133512; G02F 2001/133612; G02F 1/13439

(57) ABSTRACT

An electronic paper display screen, a method for driving the same, and an electronic paper display device are provided. The electronic paper display screen comprising: a first substrate and a second substrate opposite to each other; a plurality of insulating barrier walls dividing a space between the first substrate and the second substrate into a plurality of closed chambers; a plurality of first transparent electrodes, each of which is disposed on the first substrate and is located at a position corresponding to each of the closed chambers; a plurality of second electrodes, each of which is located in each of the closed chambers and is disposed on a sidewall of the insulating barrier walls; and a plurality of black charged particles which are disposed within each of the closed chambers and move under effect of an electric field.

### CROSS-REFERENCE TO RELATED APPLICATION

The present disclosure claims the benefit of Chinese Patent Application Disclosure No. 201810150681.8 filed on Feb. 13, 2018 in the State Intellectual Property Office of China, the whole disclosure of which is incorporated herein by reference.

### BACKGROUND OF THE INVENTION

### Field of the Invention

Embodiments of the present disclosure relate to the technical field of display technology, and especially to an electronic paper display screen, a method for driving the same, and an electronic paper display device.

### Description of the Related Art

Electronic paper (E-paper) technology has become more and more popular among consumers because of its low energy consumption, ability to maintain display in case of power off, and similar to actual paper display.

However, display of the electronic paper display device in the related art has to rely on an external light, and a contrast and brightness of the electronic paper display device during a display are substantially affected when the external light is not sufficient, and the electronic paper display device cannot display in a dark environment.

### SUMMARY OF THE INVENTION

According an aspect of the present disclosure, there is provided an electronic paper display screen comprising:

a first substrate and a second substrate opposite to each other;

a plurality of insulating barrier walls dividing a space between the first substrate and the second substrate into a plurality of closed chambers;

a plurality of first transparent electrodes, each of which is disposed on the first substrate and is located at a position corresponding to each of the closed chambers;

a plurality of second electrodes, each of which is located in each of the closed chambers and is disposed on a sidewall of the insulating barrier walls; and

a plurality of black charged particles which are disposed within each of the closed chambers and move under effect of an electric field.

In an embodiment, the electronic paper display screen further comprises first connecting electrodes which are disposed on the first substrate and are configured to electrically interconnect the plurality of first transparent electrodes.

In an embodiment, the electronic paper display screen further comprises first connecting electrodes which are disposed on the insulating barrier walls and are configured to electrically interconnect the plurality of second electrodes.

In an embodiment, the first connecting electrodes are configured to electrically interconnect the plurality of second electrodes across a side of the insulating barrier walls close to the first substrate or across a side of the insulating barrier walls close to the second substrate.

In an embodiment, the electronic paper display screen further comprises a plurality of third transparent electrodes on the second substrate, each of the third transparent electrodes being disposed at a position corresponding to each of the closed chambers.

In an embodiment, the plurality of the first transparent electrodes are independent of each other; and

wherein the electronic paper display screen further comprises second connecting electrodes which are disposed on the second substrate and are configured to electrically interconnect the plurality of the third transparent electrodes.

In an embodiment, material of the insulating barrier walls is a light shielding material.

In an embodiment, the electronic paper display screen further comprises a light shielding pattern on the first substrate or the second substrate, and a projection of the insulating barrier walls on the light shielding pattern is located within boundary of the light shielding pattern.

In an embodiment, the sidewall of the insulating barrier walls, on which the second electrode is disposed, has an inclined surface or an inwardly recessed surface.

In an embodiment, the electronic paper display screen further comprises transparent liquid within each of the closed chambers,

wherein the black charged particles are movable in the transparent liquid.

According to another aspect of the present disclosure, there is provided an electronic paper display device comprising the electronic paper display screen according to claim 1 and a backlight assembly,

wherein the backlight assembly comprises a power supply module and main light sources connected to the power supply module, and the power supply module is configured to supply power to the main light sources so that the main light sources provide the electronic paper display screen with backlight when being charged.

In an embodiment, the power supply module comprises a photoelectric conversion component configured to absorb an external light and convert the absorbed external light into electrical energy to supply power to the main light sources.

In an embodiment, the backlight assembly further comprises at least one auxiliary light source;

wherein the auxiliary light source comprises an optical collector and an optical transmission channel; and

wherein the optical collector is disposed at an entrance of the optical transmission channel and is configured to concentrate and transmit the external light into the optical transmission channel, and the optical transmission channel is configured to transmit the external light entering at the entrance thereof to an exit of the optical transmission channel.

In an embodiment, the auxiliary light source further comprises a diffuse reflector at the exit of the optical transmission channel.

In an embodiment, a concentrating port of the optical collector for concentrating the external light is arranged to face towards a display side of the electronic paper display device.

In an embodiment, the optical transmission channel is a fiber tube or a one-dimensional defect photonic transistor.

In an embodiment, the optical transmission channel comprises a transmission tube and a reflective layer within the transmission tube.

In an embodiment, the backlight assembly further comprises a photosensitive module configured to sense an intensity of the external light or configured to sense an intensity of the external light concentrated by the auxiliary light source; and a control module configured to control the power supplied by the power supply module based on the intensity of the external light sensed by the photosensitive module.

According to another aspect of the present disclosure, there is provided a method for driving the electronic paper display screen according to claim 1, wherein an electric field configured to drive a movement of the black charged particles in each of the closed chambers is generated by the first transparent electrode and the second electrode in each of the closed chambers, the driving method comprising steps of:

applying voltages to the first transparent electrode and the second electrode; and

controlling the black charged particles to move towards the first substrate through the electric field generated by the first transparent electrode and the second electrode so as to enable each of the closed chambers to display a black state, or controlling the black charged particles to move towards the second electrode through the electric field generated by the first transparent electrode and the second electrode so as to enable each of the closed chambers to display a white state.

In an embodiment, an electric field configured to drive a movement of the black charged particles in each of the closed chambers is generated by the first transparent electrode, the second electrode and the third transparent electrode in each of the closed chambers, the driving method comprising steps of:

applying voltages to the first transparent electrode, the second electrode and the third transparent electrode; and

controlling a direction of the electric field configured to drive the movement of the black charged particles in each of the closed chambers by controlling voltages of the first transparent electrode, the second electrode and the third transparent electrode, so as to drive the black charged particles to move towards the first substrate or the second substrate such that each of the closed chambers displays a black state, or to drive the black charged particles to move towards the second electrode such that each of the closed chambers displays a white state.

### BRIEF DESCRIPTION OF THE DRAWINGS

In order to more clearly illustrate the technical solutions in the embodiment of the present disclosure or in the related art, drawings to be used in the embodiments or in the related art description will be briefly described below. Apparently, the drawings in the following description are only some embodiments of the present disclosure and other drawings may be obtained by those skilled in the art without an inventive effort.

FIG. 1 is a schematic structural view of an electronic paper display device in the related art;

FIG. 2 is a schematic structural diagram of an electronic paper display screen according to an embodiment of the present disclosure;

FIG. 3 is a schematic structural diagram of another electronic paper display screen according to an embodiment of the present disclosure;

FIG. 4 is a schematic structural diagram of yet another electronic paper display screen according to an embodiment of the present disclosure;

FIG. 5 is a schematic structural diagram of still another electronic paper display screen according to an embodiment of the present disclosure;

FIG. 6 is a schematic structural diagram of still another electronic paper display screen according to an embodiment of the present disclosure;

FIG. 7 is a schematic structural diagram of still another electronic paper display screen according to an embodiment of the present disclosure;

FIG. 8a is a schematic structural diagram of an electronic paper display device according to another embodiment of the present disclosure;

FIG. 8b is a schematic structural diagram of another electronic paper display device according to another embodiment of the present disclosure;

FIG. 9 is a schematic structural diagram of an auxiliary light source according to an embodiment of the present disclosure;

FIG. 10 is a schematic structural diagram of another auxiliary light source according to an embodiment of the present disclosure; and

FIG. 11 is a schematic diagram of a method for driving an electronic paper display screen according to an embodiment of the present disclosure.

### DETAILED DESCRIPTION OF PREFERRED EMBODIMENTS

The technical solutions in the embodiment of the present disclosure are clearly and completely described in the following with reference to the accompanying drawings in the embodiment of the present disclosure. Apparently, the described embodiments are only some of the embodiments of the present disclosure, and are not all of the embodiments. All other embodiments obtained by a person of ordinary skill in the art based on the embodiment of the present disclosure without paying an inventive effort will fall within the scope of the present disclosure.

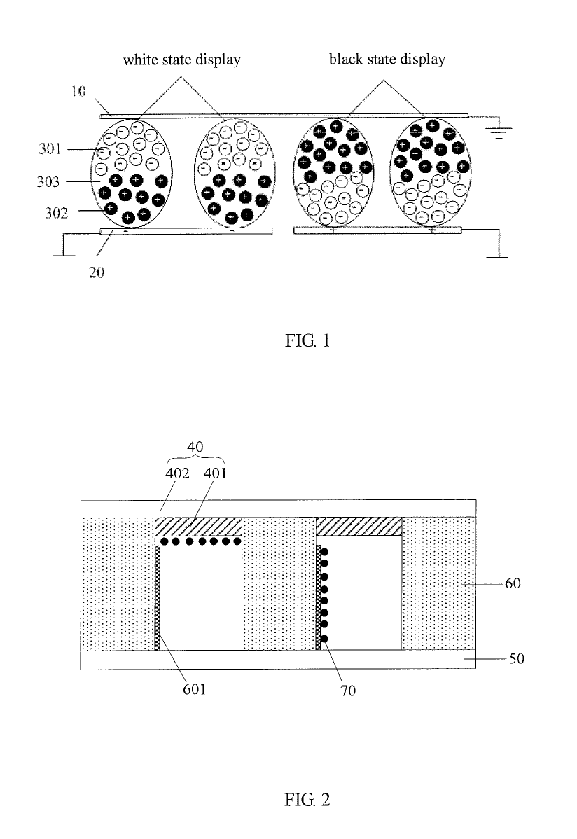

A structure of the electronic paper display device in the related art is shown in FIG. 1. A basic principle of the electronic paper display is that negatively charged white particles 301 and positively charged black particles 302 are controlled to move in transparent liquid 303 by an electric field generated by an upper electrode 10 and a lower electrode 20, and when the white particles 301 move upward, as the white particles 301 reflect an external light towards human eyes, a white state is displayed; when the black particles 302 move upward, as the black particles 302 absorb an external light, a black state is displayed.

According to a general inventive concept of the present disclosure, there is provided an electronic paper display screen comprising: a first substrate and a second substrate opposite to each other; a plurality of insulating barrier walls dividing a space between the first substrate and the second substrate into a plurality of closed chambers; a plurality of first transparent electrodes, each of which is disposed on the first substrate and is located at a position corresponding to each of the closed chambers; a plurality of second electrodes, each of which is located in each of the closed chambers and is disposed on a sidewall of the insulating barrier walls; and a plurality of black charged particles which are disposed within each of the closed chambers and move under effect of an electric field.

An embodiment of the present disclosure provides an electronic paper display screen, as shown in FIG. 2, comprising: a first substrate 40 and a second substrate 50 disposed opposite to each other; a plurality of insulating barrier walls 60 dividing a space between the first substrate 40 and the second substrate 50 into a plurality of closed chambers distributing in a direction perpendicular to a thickness of the electronic paper display screen; the first substrate 40 comprising a plurality of first transparent electrodes 401, each of which is located at a position corresponding to each of the closed chambers; the electronic paper display screen further comprises a plurality of second electrodes 601, each of which is located in each of the closed chambers and is disposed on a sidewall of the insulating barrier walls 60; a plurality of black charged particles 70 disposed within each of the closed chambers and moved under effect of an electric field.

It may be noted that, as shown in FIG. 2, the first substrate 40 may comprise a first base substrate 402 on which the plurality of first transparent electrodes 401 are disposed.

Each of the first electrodes 401 is located at a position corresponding to each of the closed chambers, taking a placement orientation of the electronic paper display screen in FIG. 2 as an example, that is, each of the first electrodes 401 is located above each of the closed chambers. Here, since the insulating barrier walls 60 divide the space so as to form the closed chambers, respectively, when each of the first electrodes 401 is located at the position corresponding to each of the closed chambers, a projection of each of the first electrodes 401 on the first base substrate 402 may or may not overlap with a projection of each of the insulating barrier walls 60 on the first base substrate 402.

In addition, each of the second electrodes 601 may be formed by directly coating a conductive film layer or by depositing a conductive film layer in way of vapor deposition on an sidewall of the insulating barrier walls 60 in each of the closed chambers; alternatively, each of the second electrodes 601 may be formed by attaching an electrode plate onto an sidewall of the insulating barrier walls 60 in each of the closed chambers.

Each of the closed chambers is surrounded and closed by the first substrate 40, the second substrate 50, and adjacent four insulating barrier walls 60. Each of the second electrodes 601 may be disposed on a partial of the area or entire area of sidewalls of insulating barrier walls 60 of each of the closed chambers. For example, if each of the closed chambers surrounded by the insulating barrier walls 60 is in a cube form, the second electrode 601 may be disposed on one side surface of the cube, alternatively, the second electrode 601 may be disposed on two or more side surfaces of the cube.

Further, the black charged particles 70 may be positively charged or negatively charged, which is not limited herein. A material of the black charged particles 70 is not limited here, and it may be, for example, a black resin doped with charged particles.

Further, a moving direction of the black charged particles 70 in each of the closed chambers is related to a direction of the electric field that drives the black charged particles 70 in each of the closed chambers to move as well as positivity or negativity of charges of the black charged particles 70. Specifically, when black charged particles 70 in a closed chamber move under an electric field only generated by a first electrode 401 and a second electrode 601, taking the black charged particles 70 being positively charged as an example, if a voltage applied to the first electrode 401 is higher than a voltage applied to the second electrode 601, the direction of the electric field is directed from the first electrode 401 to the second electrode 601, and the black charged particles 70 move towards the second electrode 601; if the voltage applied to the first electrode 401 is lower than the voltage applied to the second electrode 601, the direction of the electric field is directed from the second electrode 601 to the first electrode 401, the black charged particles 70 move towards the first substrate 40.

In addition, the electronic paper display screen provided by the embodiment of the present disclosure is supposed to be used in combination with a backlight assembly capable of providing a backlight for the electronic paper display screen.

The display principle of the electronic paper display screen is as follows: one closed chamber in the electronic paper display screen is equivalent to a sub-pixel, and the black charged particles 70 in each of the closed chambers are controlled to move therein by controlling the direction of the electric field that drives the black charged particles 70 in each of the closed chambers to move, so as to achieve a purpose of controlling each of the closed chambers to achieve a black state or a white state display. When the black charged particles 70 in the closed chamber move towards the first substrate 40 under the effect of the electric field (as shown in the closed chamber on the left side of FIG. 2), in this way, the black charged particles 70 block the light emitted from the backlight assembly. Thus, the backlight provided by the backlight assembly fails to be incident into the human eyes through the closed chamber so as to achieve a black state display; when the black charged particles 70 in the closed chamber move towards the second electrode 601 under the effect of the electric field (as shown in the closed chamber on the right side of FIG. 2), since the second electrode 601 is disposed on the sidewall of the insulating barrier wall 60, the black charged particles 70 move to the sidewall, in this way, the backlight provided by the backlight assembly may be incident into the human eyes through the closed chamber so as to achieve a white state display.

An embodiment of the present disclosure provides an electronic paper display screen. Since the electronic paper display screen is used in combination with the backlight assembly, the backlight assembly is used to provide the backlight for the electronic paper display screen, compared with the fact that the electronic paper display screen in related art emits light by a reflection of the external light on surfaces of the white particles 301, the brightness and contrast of the electronic paper display screen provided by the embodiment of the present disclosure are not affected by the external light when the electronic paper display screen displays, and the electronic paper display screen may normally display when the external light is not sufficient or an external environment is dark.

Based on the above, it may be noted that when the second substrate 50 comprises a reflective layer, the electronic paper display screen provided by the embodiment of the present disclosure may also achieve display by using the external light to serve as a light source, without the backlight assembly providing the backlight, and the principle of the electric field driving the black charged particles 70 in the closed chamber to move is the same as above, and will not be described again here. When the black charged particles 70 in the closed chamber move towards the first substrate 40 or the second substrate 50, and the external light is directed to the closed chamber, the black charged particles 70 absorb the external light to achieve the black state display; when the black charged particles 70 in the closed chamber move towards the second electrode 601, the external light is transmitted through the first electrode 401 to the reflective layer, and is reflected by the reflective layer into the human eyes, thereby realizing the white state display.

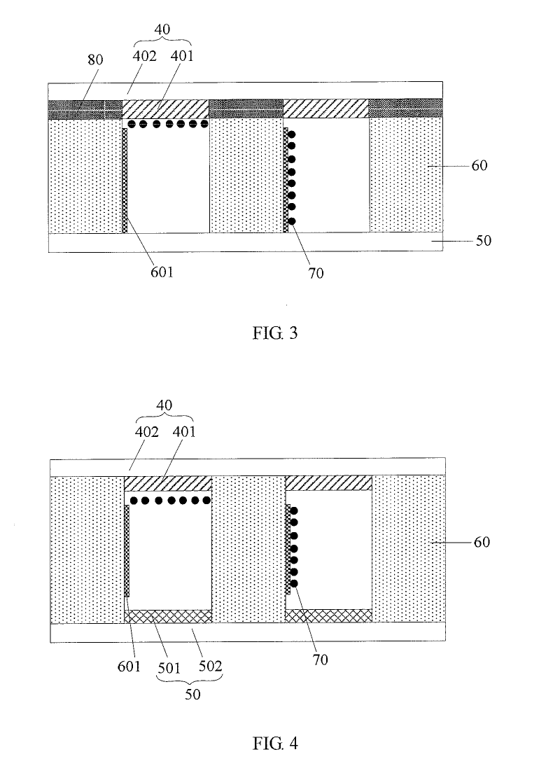

Optionally, as shown in FIG. 3, the electronic paper display screen further comprises first connecting electrodes 80 which are configured to electrically interconnect the plurality of first electrodes 401 or to electrically interconnect second electrodes 601 (in FIG. 3, first connecting electrodes 80 electrically interconnecting the plurality of first electrodes 401 are taken as an example).

When the plurality of first connection electrodes 80 is used to electrically interconnect the plurality of first electrodes 401, the plurality of first connection electrodes 80 and the plurality of the first electrodes 401 may be disposed on one same base substrate. On the basis of this, the first connection electrodes 80 and the first electrodes 401 may be formed simultaneously. When the first connecting electrode 80 is used to electrically interconnect the plurality of second electrodes 601, both the first connecting electrode 80 and the plurality of second electrodes 601 may be disposed on the insulating barrier walls 60, and the first connecting electrodes 80 extend across a side of the insulating barrier walls 60 close to the first substrate 40 or a side of the insulating barrier walls 60 close to the second substrate 50 so as to electrically interconnect adjacent second electrodes 601. On this basis, those skilled in the art may understand that, when the first connecting electrodes 80 are used to electrically interconnect the plurality of second electrodes 601, it may be noted when the first connecting electrodes 80 are disposed that, a portion of the first connecting electrode 80 on a side of the insulating barrier walls 60 close to the first substrate 40 or a side of the insulating barrier walls 60 close to the second substrate 50 should not interfere with the first electrodes 401. Alternatively, there are no overlapping areas between the first connecting electrodes 80 and the first electrodes 401 in a thickness direction of the electronic paper display screen. Further, the first connecting electrodes 80 and the second electrodes 601 may be formed simultaneously.

It may be noted that when the plurality of first electrodes 401 are electrically connected with each other through the first connecting electrodes 80, the voltages of the plurality of first electrodes 401 are the same, thus, the first electrodes 401 are equivalent to common electrodes, and the movement of the black charged particles 70 in each of the closed chambers is controlled by controlling the voltage of the second electrode 601 in each of the closed chambers so as to achieve the black state display or the white state display. For example, taking the black charged particles 70 being positively charged as an example, when the voltages of the plurality of first electrodes 401 are 3V, if the voltage of the second electrode 601 in a closed chamber is 1V, the black charged particles 70 move towards the second electrode 601; if the voltage of the second electrode 601 in a closed chamber is 5 V, the black charged particles 70 move towards the first substrate 40. Similarly, when the plurality of second electrodes 601 are electrically connected with each other through the first connecting electrode 80, the voltages of the plurality of second electrodes 601 are the same, thus the second electrodes 601 are equivalent to common electrodes, and the movement of the black charged particles 70 in each of the closed chambers is controlled by controlling the voltage of the first electrode 401 located at the position corresponding to each of the closed chambers so as to achieve the black state display or the white state display.

In the embodiment of the present disclosure, when the plurality of first electrodes 401 are electrically connected with each other through the first connecting electrodes 80, if any one of the first electrodes 401 is applied with a voltage, all the first electrodes 401 have a same voltage, which reduces the number of voltage input terminals and simplifies a manufacturing process thereof compared with a case where the plurality of first electrodes 401 are respectively applied with a voltage. Similarly, when the plurality of second electrodes 601 are electrically connected with each other through the first connecting electrodes 80, if any one of the second electrodes 601 is applied with a voltage, all the second electrodes 601 have a same voltage, which reduces the number of voltage input terminals and simplifies a manufacturing process thereof compared with a case where the plurality of second electrodes 601 are respectively applied with a voltage.

Alternatively, as shown in FIG. 4, the second substrate 50 comprises a plurality of transparent third electrodes 501, each of which is located at a position corresponding to each of the closed chambers.

As shown in FIG. 4, the second substrate 50 may comprise a second base substrate 502 on which the plurality of transparent third electrodes 501 are disposed.

Here, each of the third electrodes 501 is located at a position corresponding to each of the closed chambers, taking a placement orientation of the electronic paper display screen in FIG. 4 as an example, that is, each of the third electrodes 501 is located below each of the closed chambers. Here, a projection of each of the third electrodes 501 on the second base substrate 502 may or may not overlap with a projection of each of the insulating barrier walls 60 on the second base substrate 502.

It may be noted that, there is no limit about how to control the electric field generated by the first electrode 401, the second electrode 601, and the third electrode 501 to control the movement of the black charged particles 70 in the closed chamber so as to enable the closed chamber to achieve the black state display or the white state display. Several specific embodiments are provided below for a detailed description.

When the closed chamber achieves a black state display, in a first embodiment, no voltage is applied to the second electrode 601, the electric field generated by the first electrode 401 and the third electrode 501 controls the movement of the black charged particles 70 towards the first substrate 40 or the second substrate 50; in a second embodiment, no voltage is applied to the third electrode 501, the electric field generated by the first electrode 401 and the second electrode 601 controls the movement of the black charged particles 70 towards the first substrate 40; in a third embodiment, no voltage is applied to the first electrode 401, the electric field generated by the second electrode 601 and the third electrode 501 controls the movement of the black charged particles 70 towards the second substrate; in a fourth embodiment, voltages are applied to all of the first electrode 401, the second electrode 601, and the third electrode 501, respectively, the voltage applied to the first electrode 401 is higher than the voltage applied to the second electrode 601, the voltage applied to the second electrode 601 is higher than the voltage applied to the third electrode 501, or the voltage applied to the third electrode 501 is higher than the voltage applied to the second electrode 601, the voltage applied to the second electrode 601 is higher than the voltage applied to the first electrode 401.

When the closed chamber achieves the white state display, in a first embodiment, no voltage is applied to the third electrode 501, the electric field generated by the first electrode 401 and the second electrode 601 controls the movement of the black charged particles 70 towards the second electrode 601; in a second embodiment, no voltage is applied to the first electrode 501, the electric field generated by the second electrode 601 and the third electrode 501 controls the movement of the black charged particles 70 towards the second electrode 601; in a third embodiment, voltages are applied to all of the first electrode 401, the second electrode 601, and the third electrode 501 respectively, when the black charged particles are positively charged, the voltage applied to the first electrode 401 is higher than the voltage applied to the third electrode 501, the voltage applied to the third electrode 501 is higher than the voltage applied to the second electrode 601, when the black charged particles are negatively charged, the voltage applied to the second electrode 601 is higher than the voltage applied to the third electrode 501, the voltage applied to the third electrode 501 is higher than the voltage applied to the first electrode 401.

In the embodiment of the present disclosure, the second substrate 50 comprises a third electrode 501, since the third electrode 501 may also form an electric field with the first electrode 401 and the second electrode 601, the movement of the black charged particles 70 may be accelerated to improve a response speed of the electronic paper display screen.

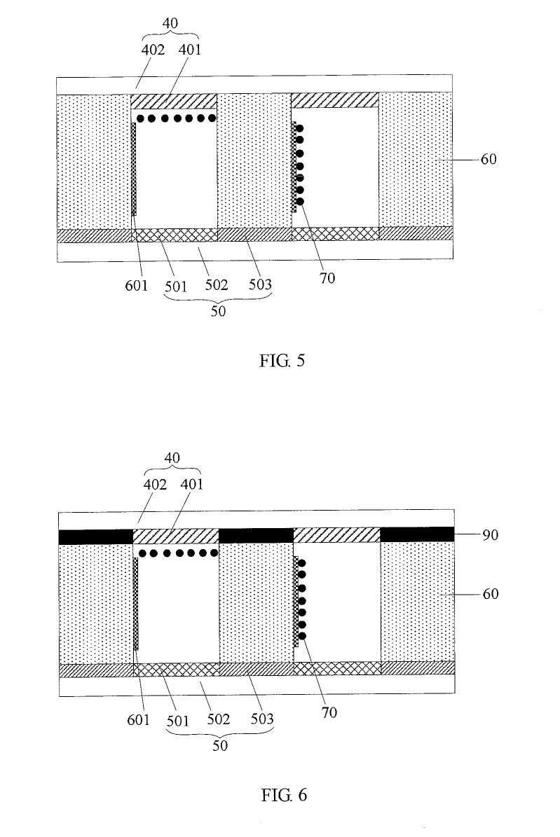

Further optionally, as shown in FIG. 5, in a case where the plurality of first electrodes 401 are independent of each other, the second substrate 50 further comprises second connecting electrodes 503 electrically interconnecting the plurality of third electrodes 501, respectively.

The second connecting electrodes 503 and the third electrodes 501 may be disposed on the second base substrate 502. On the basis of this, the second connecting electrodes 503 and the third electrodes 501 may be formed simultaneously.

Here, the plurality of first electrodes 401 being independent of each other means that the plurality of first electrodes 401 are not electrically connected with each other, and different voltages may be applied to the plurality of first electrodes 401, respectively.

It may be noted that when the plurality of first electrodes 401 are independent of each other and the plurality of third electrodes 501 are electrically connected with each other through the second connection electrodes 503, the plurality of second electrodes 601 may be electrically connected with each other through the first connecting electrodes 80, or the plurality of second electrodes 601 may also be independent of each other.

Based on the above, when the plurality of third electrodes 501 are electrically connected with each other through the second connecting electrodes 503 and the plurality of second electrodes 601 are electrically connected with each other through the first connecting electrode 80, the voltages of the plurality of third electrodes 501 are the same and the voltages of the plurality of second electrodes 601 are the same, and the third electrodes 501 and the second electrodes 601 are equivalent to the common electrodes, and the movement of the black charged particles 70 in each of the closed chambers may be controlled by controlling the voltage of the first electrode 401 corresponding to each of the closed chambers so as to achieve the black state display or the white state display. Taking the black charged particles 70 being positively charged as an example, the common voltage of the plurality of third electrodes 501 is V2, the common voltage of the plurality of second electrodes 601 is V1, V2 is higher than V1, and the potentials of the plurality of independent first electrodes 401 are switched between V0 and V3, where V0 is lower than V1, and V3 is higher than V2. Then, according to the foregoing principle of achieving the black state display or the white state display, the black charged particles 70 will move back and forth between the first electrode 401 and the second electrode 601 to achieve switching of the black state display or the white state display. When the plurality of third electrodes 501 are electrically connected with each other through the second connecting electrodes 503, the voltages of the plurality of third electrodes 501 are the same, the third electrode 501 is equivalent to the common electrode, and the plurality of second electrodes 601 are independent of each other and the plurality of first electrodes 401 are independent of each other, and the movement of the black charged particles 70 in each of the closed chambers may be controlled by controlling the voltage(s) of the second electrodes 601 and/or the first electrodes 401 corresponding to each of the closed chambers so as to achieve the black state display or white state display. For example, the black charged particles 70 are positively charged, and voltages are applied to the first electrode 401, the second electrode 601 and the third electrode 501 respectively, the common voltage of the plurality of third electrodes 501 is V0, and the voltages of the plurality of first electrodes 401 are switched between V1 and V2, the voltages of the plurality of second electrodes 601 are switched between V3 and V4. For example, when the voltage of the first electrode 401 is V2, the voltage of the second electrode 601 is V3, when the voltage of the first electrode 401 is V1, the voltage of the second electrode 601 is V4, wherein V2 is greater than V0, V0 is greater than V1, V4 is greater than V1 and less than V0, and V3 is less than V0 and less than V2, according to the principle of achieving the black state display or white state display described above, the black charged particles 70 will move back and forth between the first electrode 401 and the second electrode 601 to achieve switching of the black state display or the white state display. For example, when the voltage of the first electrode 401 is V2, the voltage of the second electrode 601 is V3, and when the voltage of the first electrode 401 is V1, the voltage of the second electrode 601 is V4, and V1 is greater than V0, V0 is greater than V2, V4 is less than V1 and greater than V0, and V3 is less than V0 and less than V2. According to the principle of achieving the black state display or the white state display, the black charged particles 70 will move back and forth between the third electrode 501 and the second electrode 601 so as to achieve the switching of the black state display or the white state display.

In the embodiment of the present disclosure, since the plurality of third electrodes 501 are electrically connected with each other through the second connecting electrode 503, therefore, if any one of the third electrodes 501 is applied with a voltage, all the third electrodes 501 have the same voltage, which reduces the number of voltage input terminals and simplifies a manufacturing process thereof compared with a case where the plurality of third electrodes 501 are respectively applied with voltages.

In the case where the black state display is achieved in two adjacent closed chambers, respectively, if the material of the insulating barrier walls 60 is a transparent material and there is no light shielding pattern provided thereon, the light emitted by the backlight assembly would exit from a region between the two closed chambers, thereby causing a light leakage and adversely affecting the display. Based on this, in the embodiment of the present disclosure, alternatively, as shown in FIG. 6, the material of the insulating barrier walls 60 is a light shielding material; and/or the first substrate 40 or the second substrate 50 further comprises a light shielding pattern 90, and a projection of each of the insulating barrier walls 60 on the light shielding pattern 90 is located within the boundary of the light shielding pattern 90.

The projection of each of the insulating barrier walls 60 on the light shielding pattern 90 being located within the boundary of the light shielding pattern 90 may be a case where a projection of a boundary of each of the insulating barrier walls 60 on the light shielding pattern 90 may overlap with the boundary of the light shielding pattern 90; or the boundary of the light shielding pattern 90 surrounds the projection of the boundary of each of the insulating barrier walls 60 on the light shielding pattern 90.

In the embodiment of the present disclosure, the material of the insulating barrier walls 60 is provided as a light shielding material, or the light shielding pattern 90 is provided so as to prevent the light leakage occurring in the region between the two adjacent closed chambers, thereby adversely affecting the display.

Referring to FIG. 6, if the sidewall of the insulating barrier walls 60 on which the second electrodes 601 are disposed is perpendicular to the first substrate 40 or the second substrate 50, the black charged particles 70 will be attracted to the sidewall of the insulating barrier walls 60 by the second electrode 601 when the closed chamber achieves the white state display, so that when the backlight emitted by the backlight assembly passes through the closed chamber, a part of the backlight may be blocked by the black charged particles 70, thereby adversely affecting the brightness when the white state is displayed.

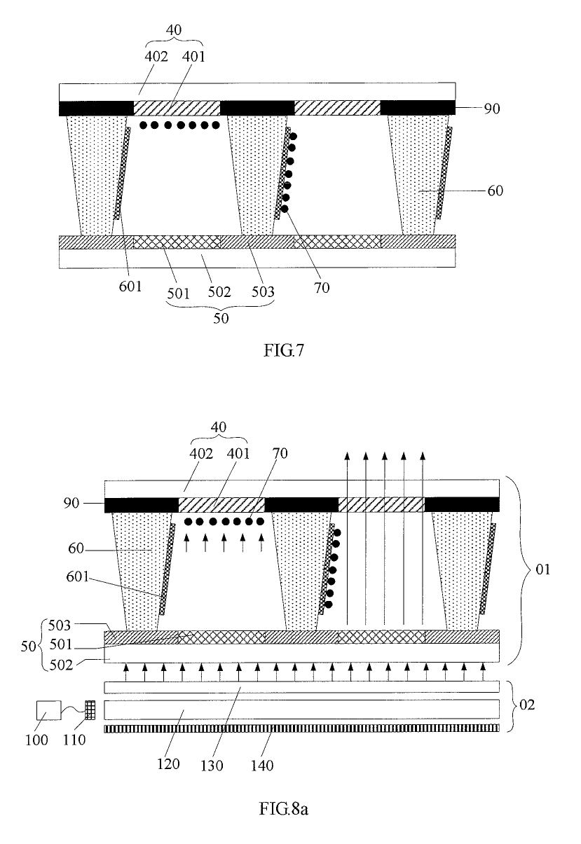

Based on this, in the embodiment of the present disclosure, further alternatively, as shown in FIG. 7, the sidewall of the insulating barrier walls 60 on which the second electrodes 601 is disposed is an inclined surface or an inwardly recessed surface.

The sidewall of the insulating barrier walls 60 on which the second electrodes 601 is disposed being an inclined surface means that the sidewall is non-perpendicular or inclined with respect to the first substrate 40 or the second substrate 50. The sidewall of each of the insulating barrier walls 60 disposed with corresponding one of the second electrodes 601 being an inwardly recessed surface means that a surface of the sidewall is recessed towards an interior of the sidewall.

In the embodiment of the present disclosure, since the sidewall of the insulating barrier walls 60 on which the second electrodes 601 is disposed is an inclined surface or an inwardly recessed surface, the black charged particles 70 are attracted to the inclined surface or the inwardly recessed surface when the white state display is achieved, which reduces the risk of the black charged particles 70 blocking the backlight such that the backlight cannot exit from each of the closed chambers.

Optionally, the electronic paper display screen further comprises a transparent liquid disposed within each of the closed chambers; the black charged particles 70 may move in the transparent liquid.

The transparent liquid in the closed chambers of the embodiment of the present disclosure may be the same as the transparent liquid in a microcapsule or a microcup in the electronic paper display device in the related art. By way of example, the transparent liquid may be tetrachloroethylene or xylene.

In the embodiment of the present disclosure, the transparent liquid is disposed in the closed chambers, so that the black particles may be in a suspended state in the transparent liquid, thereby reducing the influence of an external force, such as gravity, on the black particles, thereby facilitating the movement of the black charged particles 70, and improving the response speed of the electronic paper display screen and avoiding afterimage problems when the electronic paper display screen performing display.

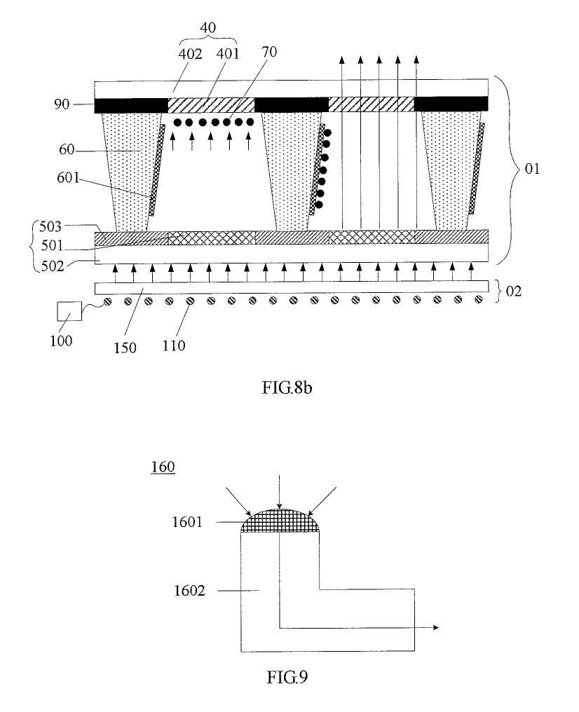

An embodiment of the present disclosure provides an electronic paper display device, as shown in FIGS. 8a and 8b, comprising the above-described electronic paper display screen 01 and the backlight assembly 02; the backlight assembly 02 comprises a power supply module 100 and main light sources 110 connected to the power supply module 100. The power supply module 100 is configured to supply power to the main light sources 110 so that the main light sources 110 provide the electronic paper display screen 01 with backlight when being charged.

The power supply module 100 may be a battery or an AC circuit.

Here, the backlight assembly 02 may be a side-lit backlight assembly as shown in FIG. 8a or a direct-lit backlight assembly as shown in FIG. 8b. As shown in FIG. 8a, when the backlight assembly 02 is a side-lit backlight assembly, the backlight assembly 02 comprises a light guide plate 120 and main light sources 110 disposed at a side of the light guide plate 120. In addition, the backlight assembly 02 may further comprise an optical film 130 disposed on a side of the light guide plate 120 close to the electronic paper display screen 01 and/or a reflective sheet 140 disposed on a side of the light guide plate 120 away from the electronic paper display screen 01. The optical film 130 may be, but not limited to, a diffusion sheet. As shown in FIG. 8b, when the backlight assembly 02 is the direct-lit backlight assembly, the backlight assembly 02 comprises a diffusion plate 150 and main light sources 110 disposed on a side of the diffusion plate 150 away from the electronic paper display screen 01. Here, the main light sources 110 may be disposed on a PCB (Printed Circuit Board).

In addition, the main light sources 110 may be, for example, LED (Light-Emitting Diode) lamps or Cold Cathode Fluorescent Lamps (abbreviated as “CCFL”).

An embodiment of the present disclosure provides an electronic paper display device comprising an electronic paper display screen 01 and a backlight assembly 02. The backlight assembly 02 comprises a power supply module 100 and main light sources 110 connected to the power supply module 100. The main light sources 110 may provide backlight to the electronic paper display screen 01 when the power supply module 100 is charged. When the black charged particles 70 in the closed chamber move towards the first substrate 40 under the effect of the electric field (as shown in the closed chamber on the left side of FIG. 8a), thus the black charged particles 70 block the backlight emitted by the backlight assembly 02, and the backlight provided by the backlight assembly 02 cannot be transmitted through the closed chamber to enter the human eyes, thereby achieving the black state display; when the black charged particles 70 in the closed chamber move towards the second electrode 601 under the effect of the electric field (as shown in the closed chamber on the right side of FIG. 8a), since the second electrode 601 is disposed on the sidewall of the insulating barrier wall 60, the black charged particles 70 move to the sidewall, in this way, the backlight provided by the backlight assembly 02 may be incident into the human eyes through the closed chamber so as to achieve the white state display. Since the electronic paper display screen 01 of the electronic paper display device is used in combination with the backlight assembly 02, the backlight assembly 02 is used to provide the backlight for the electronic paper display screen 01, compared with the electronic paper display screen in the related art emitting light by a reflection of the external light on surfaces of the white particles 301, the brightness and contrast of the electronic paper display device provided by the embodiment of the present disclosure are not adversely affected by the external light when the electronic paper display device perform a display, and the electronic paper display device may normally perform a display when the external light is not sufficient or an external environment is dark.

Optionally, the power supply module 100 comprises a photoelectric conversion component configured to absorb the external light and convert the absorbed external light into electrical energy to supply power to the main light sources 110.

The photoelectric conversion component serves as a solar battery.

In the embodiment of the present disclosure, since the power supply module 100 comprises a photoelectric conversion component which absorbs the external light and converting the absorbed external light into electrical energy to supply power to the main light sources 110, thereby achieving a purpose of power saving.

Optionally, as shown in FIG. 9, the backlight assembly 02 further comprises at least one auxiliary light source 160, which comprises an optical collector 1601 and an optical transmission channel 1602. The optical collector 1601 is disposed at an entrance of the optical transmission channel 1602 for concentrating and transmitting the external light into the optical transmission channel 1602. The optical transmission channel 1602 is configured to transmit an external light entering entrance of the optical transmission channel 1602 to an exit of the optical transmission channel 1602.

The optical collector 1601 is also called an optical concentrator, and is composed of an aperture and a condenser. The condenser comprises one or more lenses, and serves to concentrate the light.

Here, a structure of the optical transmission channel 1602 is not limited as long as the optical transmission channel 1602 may transmit the light entering the entrance of the optical transmission channel 1602 to the exit of the optical transmission channel 1602. Structures of three kinds of optical transmission channels 1602 are provided below.

The first kind of optical transmission channel 1602 is a fiber tube.

The second kind of optical transmission channel 1602 is a one-dimensional defect photonic transistor.

The third kind of optical transmission channel 1602 comprises a transmission tube and a reflective layer disposed within the transmission tube.

Based on this, the position where the auxiliary light source 160 is arranged is related to the type of the backlight assembly 02. Specifically, when the backlight assembly 02 is a side-lit backlight assembly, the light emitted by the auxiliary light source 160 should be incident on the side surface of the light guide plate 120, thus, a light exit of the auxiliary light source 160 is located on the side surface of the light guide plate 120, and the auxiliary light source 160 may also be disposed on the side surface of the light guide plate 120. Since the main light sources 110 are also disposed on the side surface of the light guide plate 120, the main light sources 110 and the auxiliary light source 160 may be disposed on one same side surface or different side surfaces of the light guide plate 120. When the main light sources 110 and the auxiliary light source 160 are disposed on one same side surface of the light guide plate 120, the main light sources 110 and the auxiliary light source 160 may be disposed in a thickness direction of the light guide plate 120, taking the displacement orientation of the electronic paper display device shown in FIG. 8a as an example, the main light sources 110 and the auxiliary light source 160 are disposed on the side surface of the light guide plate 120, and one is on the other. In addition, when the backlight assembly 02 is a side-lit backlight assembly, further alternatively the embodiment of the present disclosure comprises at least one row of auxiliary light sources 160 arranged in a length direction of a side surface of the light guide plate 120. When the backlight assembly 02 is a direct-lit backlight assembly, the auxiliary light source 160 is disposed on a side of the diffusion plate 150 away from the electronic paper display screen 01. On the basis of this, in the embodiment of the present disclosure, alternatively, the backlight assembly 02 comprises a plurality of auxiliary light sources 160, the auxiliary light sources 160 and the main light sources 110 may be alternately and evenly distributed on a side of the diffusion plate 150 away from the electronic paper display screen 01.

It may be noted that the side surface of the light guide plate 120 refers to a surface other than a light-emitting surface of the light guide plate 120 and a surface opposite to the light-emitting surface.

The electronic paper display device provided by the embodiment of the present disclosure further comprises auxiliary light sources 160 which provide backlight for the electronic paper display screen 01 together with the main light sources 110. Since the auxiliary light source 160 supplies the concentrated external light to the electronic paper display screen 01 as backlight, thus achieving a purpose of saving power.

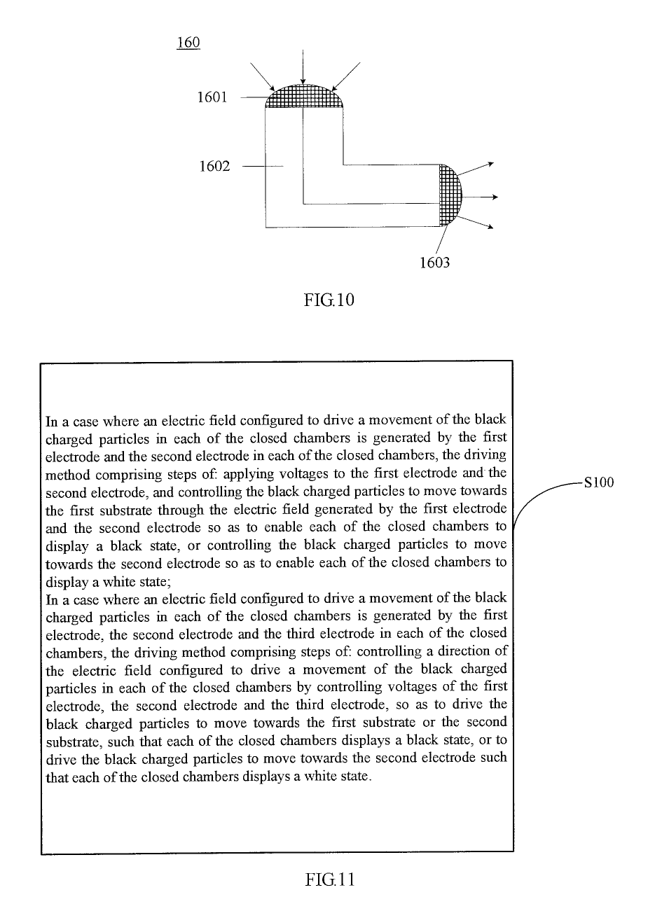

Further alternatively, as shown in FIG. 10, the auxiliary light source 160 further comprises: a diffuse reflector 1603 disposed at the exit of the light transmission channel 1602.

In the embodiment of the present disclosure, the diffuse reflector 1603 is disposed at the exit of the light transmission channel 1602 to ensure that the light emitted by the auxiliary light source 160 is uniform.

Since the display side is usually arranged upward when the electronic paper display device is in use, if a concentrating port of the optical collector 1601 for concentrating external light faces away from the display side, the optical collector 1601 collects less external light, thus, an intensity of the light emitted by the auxiliary light source 160 is weak. Based on this, in the embodiment of the present disclosure, alternatively, the concentrating port of the optical collector 1601 for concentrating the external light is directed towards the display side of the electronic paper display device, so that the optical collector 1601 may advantageously absorb more external light and the brightness of the light emitted from the auxiliary light source 160 is improved.

It may be noted that the display side of the electronic paper display device refers to a light exit side of the electronic paper display device, that is, the side on which the display surface of the electronic paper display device is located.

Alternatively, the backlight assembly 02 further comprises a photosensitive module configured to sense the intensity of the external light or configured to sense an intensity of the external light concentrated by the auxiliary light source 160; and a control module configured to control the power supplied by the power supply module 100 based on the intensity of the external light sensed by the photosensitive module.

It may be noted that the control module is configured to control the power provided by the power supply module 100 according to the intensity of the external light sensed by the photosensitive module. It may be that, when the intensity of the external light sensed by the photosensitive module is higher than a certain threshold, the control module controls the power supply module 100 to be shut down and only the auxiliary light source 160 provides backlight for the electronic paper display screen 01; when the intensity of the external light sensed by the photosensitive module is lower than a certain threshold, the control module controls the power supply module 100 to be turned on so as to provide the main light sources 110 with power, thus the auxiliary light source 160 and the main light sources 110 collectively provide backlight for the electronic paper display screen 01. When the control module controls the power supply module 100 to provide power to the main light sources 110, the power provided by the power supply module 100 may be a certain value, that is, the brightness of the light emitted by the main light sources 110 is constant; or the power provided by the power supply module 100 may be associated with the intensity of the external light sensed by the photosensitive module, the greater the intensity of the external light sensed by the photosensitive module, the smaller the power provided by the power supply module 100, that is, the smaller the brightness of the light emitted by the main light sources 110, the smaller the intensity of the external light sensed by the photosensitive module, the greater the power provided by the power supply module 100, that is, the greater the brightness of the light emitted by the main light sources 110.

In the embodiment of the present disclosure, the backlight module 02 further comprises a photosensitive module and a control module. Since the control module may control the electric power provided by the power supply module 100 according to the intensity of the external light sensed by the photosensitive module, the main light sources 110 and the auxiliary light source 160 may be controlled to appropriately cooperate with each other, so that the brightness of the light emitted by the backlight assembly 02 is neither too bright nor too dark, which improves the user experience to the electronic paper display device.

The embodiment of the present disclosure further provides a method for driving the electronic paper display screen, as shown in FIG. 11.

S100. In a case where an electric field configured to drive a movement of the black charged particles 70 in each of the closed chambers is generated by the first electrode 401 and the second electrode 601 in each of the closed chambers, the driving method comprising steps of: applying voltages to the first electrode 401 and the second electrode 601, and controlling the black charged particles 70 to move towards the first substrate 40 through the electric field generated by the first electrode 401 and the second electrode 601 so as to enable each of the closed chambers to display a black state, or controlling the black charged particles 70 to move towards the second electrode 601 so as to enable each of the closed chambers to display a white state.

It may be noted that, a moving direction of the black charged particles 70 in each of the closed chambers is related to a direction of the electric field that drives the black charged particles 70 to move in each of the closed chambers and positivity or negativity of charges of the black charged particles 70. Taking the black charged particles 70 being positively charged as an example, if the voltage applied to the first electrode 401 is higher than the voltage applied to the second electrode 601, the direction of the electric field is directed from the first electrode 401 to the second electrode 601, the black charged particles 70 move towards the second electrode 601; if the voltage applied to the first electrode 401 is lower than the voltage applied to the second electrode 601, the direction of the electric field is directed from the second electrode 601 to the first electrode 401, the black charged particles 70 move towards the first substrate 40. When the black charged particles 70 are negatively charged, voltages are applied to the first electrode 401 and the second electrode 601 respectively such that the direction of the electric field generated by the first electrode 401 and the second electrode 601 is opposite to that when the black charged particles 70 are positively charged, which is not repeated here.

In a case where an electric field configured to drive a movement of the black charged particles in each of the closed chambers is generated by the first electrode 401, the second electrode 601 and the third electrode 501 in each of the closed chambers, the driving method comprising steps of: controlling a direction of the electric field configured to drive a movement of the black charged particles 70 in each of the closed chambers by controlling voltages of the first electrode 401, the second electrode 601 and the third electrode 501, so as to drive the black charged particles 70 to move towards the first substrate 40 or the second substrate 50, such that each of the closed chambers displays a black state, or to drive the black charged particles 70 to move towards the second electrode 601 such that each of the closed chambers displays a white state.

There is no limit about how to control the electric field generated by the first electrode 401, the second electrode 601, and the third electrode 501 to control the movement of the black charged particles 70 in the closed chamber so as to enable the closed chamber to achieve the black state display or the white state display. Several specific embodiments are provided below for a detailed description.

When the closed chamber achieves a black state display, in a first embodiment, no voltage is applied to the second electrode 601, the electric field generated by the first electrode 401 and the third electrode 501 controls the movement of the black charged particles 70 towards the first substrate 40 or the second substrate 50; in a second embodiment, no voltage is applied to the third electrode 501, the electric field generated by the first electrode 401 and the second electrode 601 controls the movement of the black charged particles 70 towards the first substrate 40; in a third embodiment, no voltage is applied to the first electrode 401, the electric field generated by the second electrode 601 and the third electrode 501 controls the movement of the black charged particles 70 towards the second substrate; in a fourth embodiment, voltages are applied to all of the first electrode 401, the second electrode 601, and the third electrode 501, respectively, the voltage applied to the first electrode 401 is higher than the voltage applied to the second electrode 601, the voltage applied to the second electrode 601 is higher than the voltage applied to the third electrode 501, or the voltage applied to the third electrode 501 is higher than the voltage applied to the second electrode 601, the voltage applied to the second electrode 601 is higher than the voltage applied to the first electrode 401.

When the closed chamber achieves the white state display, in a first embodiment, no voltage is applied to the third electrode 501, the electric field generated by the first electrode 401 and the second electrode 601 controls the movement of the black charged particles 70 towards the second electrode 601; in a second embodiment, no voltage is applied to the first electrode 501, the electric field generated by the second electrode 601 and the third electrode 501 controls the movement of the black charged particles 70 towards the second electrode 601; in a third embodiment, voltages are applied to all of the first electrode 401, the second electrode 601, and the third electrode 501 respectively, when the black charged particles are positively charged, the voltage applied to the first electrode 401 is higher than the voltage applied to the third electrode 501, the voltage applied to the third electrode 501 is higher than the voltage applied to the second electrode 601, when the black charged particles are negatively charged, the voltage applied to the second electrode 601 is higher than the voltage applied to the third electrode 501, the voltage applied to the third electrode 501 is higher than the voltage applied to the first electrode 401.

The embodiment of the present disclosure provides a method for driving an electronic paper display screen, which has same features and beneficial effects as the electronic paper display screen provided by the above embodiments, since the structures and beneficial effects of the electronic paper display screen are described in detail in the above embodiments, and thus will not be described again here.

Embodiments of the present disclosure provide an electronic paper display screen, a method for driving the same, and an electronic paper display device. Since the electronic paper display screen controls the direction of the electric field that drives the black charged particles in each of the closed chambers to move so as to control the movement of the black charged particles in each of the closed chambers, a purpose of controlling each of the closed chambers to achieve a black state display or a white state display is fulfilled. When the black charged particles in the closed chamber move towards the first substrate under the effect of the electric field, in this way, the black charged particles block the light emitted from the backlight assembly. Thus, the backlight provided by the backlight assembly fails to be incident into the human eyes through the closed chamber and a black state display is achieved; when the black charged particles in the closed chamber move towards the second electrode under the effect of the electric field, since the second electrode is disposed on the sidewall of the insulating barrier wall, the black charged particles move to the sidewall, in this way, the backlight provided by the backlight assembly may be incident into the human eyes through the closed chamber and a white state display is achieved. Since the electronic paper display screen is used in combination with the backlight assembly, the backlight assembly is used to provide the backlight for the electronic paper display screen, compared with the electronic paper display screen in the related art emitting light by a reflection of the external light on surfaces of the white particles, the brightness and contrast of the electronic paper display device provided by the embodiment of the present disclosure are not adversely affected by the external light when the electronic paper display device perform a display, and the electronic paper display device may normally perform a display when the external light is not sufficient or an external environment is dark.

The above description is only some specific embodiments of the present disclosure, although the scope of the present disclosure is not limited thereto. Those skilled in the art may easily envisage modifications or substitutions within the technical scope of the disclosure, which may fall within a protective scope of the present disclosure. Therefore, the protective scope of the present disclosure should be defined by the scope of the claims.

What is claimed is:

1. An electronic paper display screen comprising:
a first substrate and a second substrate opposite to each other;
a plurality of insulating barrier walls dividing a space between the first substrate and the second substrate into a plurality of closed chambers;
a plurality of first transparent electrodes, each of which is disposed on the first substrate and is located at a position corresponding to each of the closed chambers;
a plurality of second electrodes, each of which is located in each of the closed chambers and is disposed on a sidewall of the insulating barrier walls; and
a plurality of black charged particles which are disposed within each of the closed chambers and move under effect of an electric field.

2. The electronic paper display screen according to claim 1, further comprising first connecting electrodes which are disposed on the first substrate and are configured to electrically interconnect the plurality of first transparent electrodes.

3. The electronic paper display screen according to claim 1, further comprising first connecting electrodes which are disposed on the insulating barrier walls and are configured to electrically interconnect the plurality of second electrodes.

4. The electronic paper display screen according to claim 3, wherein the first connecting electrodes are configured to electrically interconnect the plurality of second electrodes across a side of the insulating barrier walls close to the first substrate or across a side of the insulating barrier walls close to the second substrate.

5. The electronic paper display screen according to claim 1, further comprising a plurality of third transparent electrodes on the second substrate, each of the third transparent electrodes being disposed at a position corresponding to each of the closed chambers.

6. The electronic paper display screen according to claim 5, wherein the plurality of the first transparent electrodes are independent of each other; and
wherein the electronic paper display screen further comprises second connecting electrodes which are disposed on the second substrate and are configured to electrically interconnect the plurality of the third transparent electrodes.

7. The electronic paper display screen according to claim 1, wherein material of the insulating barrier walls is a light shielding material.

8. The electronic paper display screen according to claim 7, further comprising a light shielding pattern on the first substrate or the second substrate, and a projection of the insulating barrier walls on the light shielding pattern is located within boundary of the light shielding pattern.

9. The electronic paper display screen according to claim 1, wherein the sidewall of the insulating barrier walls, on which the second electrode is disposed, has an inclined surface or an inwardly recessed surface.

10. The electronic paper display screen according to claim 1, further comprising transparent liquid within each of the closed chambers,
wherein the black charged particles are movable in the transparent liquid.

11. An electronic paper display device comprising the electronic paper display screen according to claim 1 and a backlight assembly,
wherein the backlight assembly comprises a power supply module and main light sources connected to the power supply module, and the power supply module is configured to supply power to the main light sources so that the main light sources provide the electronic paper display screen with backlight when being charged.

12. The electronic paper display device according to claim 11, wherein the power supply module comprises a photoelectric conversion component configured to absorb an external light and convert the absorbed external light into electrical energy to supply power to the main light sources.

13. The electronic paper display device according to claim 11, wherein the backlight assembly further comprises at least one auxiliary light source;
wherein the auxiliary light source comprises an optical collector and an optical transmission channel; and
wherein the optical collector is disposed at an entrance of the optical transmission channel and is configured to concentrate and transmit the external light into the optical transmission channel, and the optical transmission channel is configured to transmit the external light entering at the entrance thereof to an exit of the optical transmission channel.

14. The electronic paper display device according to claim 13, wherein the auxiliary light source further comprises a diffuse reflector at the exit of the optical transmission channel.

15. The electronic paper display device according to claim 13, wherein a concentrating port of the optical collector for concentrating the external light is arranged to face towards a display side of the electronic paper display device.

16. The electronic paper display device according to claim 13, wherein the optical transmission channel is a fiber tube or a one-dimensional defect photonic transistor.

17. The electronic paper display device according to claim 13, wherein the optical transmission channel comprises a transmission tube and a reflective layer within the transmission tube.

18. The electronic paper display device according to claim 13, wherein the backlight assembly further comprises a photosensitive module configured to sense an intensity of the external light or configured to sense an intensity of the external light concentrated by the auxiliary light source; and a control module configured to control the power supplied by the power supply module based on the intensity of the external light sensed by the photosensitive module.

19. A method for driving the electronic paper display screen according to claim 1, wherein an electric field configured to drive a movement of the black charged particles in each of the closed chambers is generated by the first transparent electrode and the second electrode in each of the closed chambers, the driving method comprising steps of:
applying voltages to the first transparent electrode and the second electrode; and
controlling the black charged particles to move towards the first substrate through the electric field generated by the first transparent electrode and the second electrode so as to enable each of the closed chambers to display a black state, or controlling the black charged particles to move towards the second electrode through the electric field generated by the first transparent electrode and the second electrode so as to enable each of the closed chambers to display a white state.

20. A method for driving the electronic paper display screen according to claim 5, wherein an electric field configured to drive a movement of the black charged particles in each of the closed chambers is generated by the first transparent electrode, the second electrode and the third transparent electrode in each of the closed chambers, the driving method comprising steps of:
applying voltages to the first transparent electrode, the second electrode and the third transparent electrode; and
controlling a direction of the electric field configured to drive the movement of the black charged particles in each of the closed chambers by controlling voltages of the first transparent electrode, the second electrode and the third transparent electrode, so as to drive the black charged particles to move towards the first substrate or the second substrate such that each of the closed chambers displays a black state, or to drive the black charged particles to move towards the second electrode such that each of the closed chambers displays a white state.
